(19) United States
(12) Patent Application Publication
(10) Pub. No.: US 2012/0287163 A1
(43) Pub. Date: Nov. 15, 2012

(54) Scaling of Visual Content Based Upon User Proximity

(75) Inventor: Amir Djavaherian, San Francisco, CA (US)

(73) Assignee: Apple Inc., Cupertino, CA (US)

(21) Appl. No.: 13/104,346

(22) Filed: May 10, 2011

(51) Int. Cl. G09G 5/00

(52) U.S. Cl. 345/667

(57) ABSTRACT

A mechanism is disclosed for automatically scaling the size of a set of visual content based upon how close a user's face is to a display. In one implementation, the mechanism initially causes a set of visual content on a display to be sized according to a first scaling factor when the user's face is at a first distance from the display. The mechanism then determines that the user's face has moved relative to the display such that the user's face is no longer at the first distance from the display. In response, the mechanism causes the set of visual content on the display to be sized according to a second and different scaling factor. By doing so, the mechanism effectively causes the display size of the visual content to automatically change as the distance between the user's face and the display changes.

### BACKGROUND

Many of today's computing devices allow a user to scale the visual content that is being displayed to a size of the user's liking. For example, some smart phones and tablet computing devices allow a user to put two fingers on a touch sensitive display and either pinch the fingers together or spread them apart. Pinching the fingers together causes the display size of the visual content to be reduced, while spreading the fingers apart causes the display size of the visual content to be enlarged. By adjusting the scale of the visual content, the user can set the visual content to a size that is comfortable for him/her.

Often, during the course of using a computing device, especially one that is portable such as a smart phone or a tablet, a user may position the display of the computing device at different distances from the user's face at different times. For example, when the user starts using a computing device, the user may hold the display of the computing device at a relatively close distance X from the user's face. As the user's arm becomes fatigued, the user may set the computing device down on a table or on the user's lap, which is at a farther distance Y from the user's face. If the difference between the distances X and Y is significant, the scale of the visual content that was comfortable for the user at distance X may no longer be comfortable for the user at distance Y (e.g. the font size that was comfortable at distance X may be too small at distance Y). As a result, the user may have to manually readjust the scale of the visual content to make it comfortable at distance Y. If the user moves the display to different distances many times, the user may need to manually readjust the scale of the visual content many times. This can become inconvenient and tedious.

### BRIEF DESCRIPTION OF THE DRAWING(S)

FIG. 1 shows a block diagram of a sample computing device in which one embodiment of the present invention may be implemented.

FIG. 2 shows a flow diagram for a calibration procedure involving a distance determining component, in accordance with one embodiment of the present invention.

FIG. 3 shows a flow diagram for an automatic scaling procedure involving a distance determining component, in accordance with one embodiment of the present invention.

FIG. 4 shows a flow diagram for a calibration procedure involving a user-facing camera, in accordance with one embodiment of the present invention.

FIG. 5 shows a flow diagram for an automatic scaling procedure involving a user-facing camera, in accordance with one embodiment of the present invention.

### DETAILED DESCRIPTION OF EMBODIMENT(S)

### Overview

In accordance with one embodiment of the present invention, a mechanism is provided for automatically scaling the size of a set of visual content based, at least in part, upon how close a user's face is to a display. By doing so, the mechanism relieves the user from having to manually readjust the scale of the visual content each time the user moves the display to a different distance from his/her face. In the following description, the term visual content will be used broadly to encompass any type of content that may be displayed on a display device, including but not limited to text, graphics (e.g. still images, motion pictures, etc.), webpages, graphical user interface components (e.g. buttons, menus, icons, etc.), and any other type of visual information.

According to one embodiment, the mechanism automatically rescales a set of visual content in the following manner. Initially, the mechanism causes a set of visual content on a display to be sized according to a first scaling factor when the user's face is at a first distance from the display. The mechanism then determines that the user's face has moved relative to the display such that the user's face is no longer at the first distance from the display. This determination may be made, for example, based upon sensor information received from one or more sensors. In response to a determination that the user's face has moved relative to the display, the mechanism causes the set of visual content on the display to be sized according to a second and different scaling factor. By doing so, the mechanism effectively causes the display size of the visual content to automatically change as the distance between the user's face and the display changes.

As used herein, the term scaling factor refers generally to any one or more factors that affect the display size of a set of visual content. For example, in the case where the visual content includes text, the scaling factor may include a font size for the text. In the case where the visual content includes graphics, the scaling factor may include a magnification or zoom factor for the graphics.

In one embodiment, as the user's face gets closer to the display, the scaling factor, and hence, the display size of the visual content is made smaller (down to a certain minimum limit), and as the user's face gets farther from the display, the scaling factor, and hence, the display size of the visual content is made larger (up to a certain maximum limit). In terms of text, this may mean that as the user's face gets closer to the display, the font size is made smaller, and as the user's face gets farther away from the display, the font size is made larger. In terms of graphics, this may mean that as the user's face gets closer to the display, the magnification factor is decreased, and as the user's face gets farther from the display, the magnification factor is increased. In this embodiment, the mechanism attempts to maintain the visual content at a comfortable size for the user regardless of how far the display is from the user's face. Thus, this mode of operation is referred to as comfort mode.

In an alternative embodiment, as the user's face gets closer to the display, the scaling factor, and hence, the display size of the visual content is made larger (thereby giving the impression of “zooming in” on the visual content), and as the user's face gets farther from the display, the scaling factor, and hence, the display size of the visual content is made smaller (thereby giving the impression of “panning out” from the visual content). Such an embodiment may be useful in various applications, such as in games with graphics, image/video editing applications, mapping applications, etc. By moving his/her face closer to the display, the user is in effect sending an implicit signal to the application to “zoom in” (e.g. to increase the magnification factor) on a scene or a map, and by moving his/her face farther from the display, the user is sending an implicit signal to the application to “pan out” (e.g. to decrease the magnification factor) from a scene or a map. Because this mode of operation provides a convenient way for the user to zoom in and out of a set of visual content, it is referred to herein as zoom mode.

The above modes of operation may be used advantageously to improve a user's experience in viewing a set of visual content on a display.

### Sample Computing Device

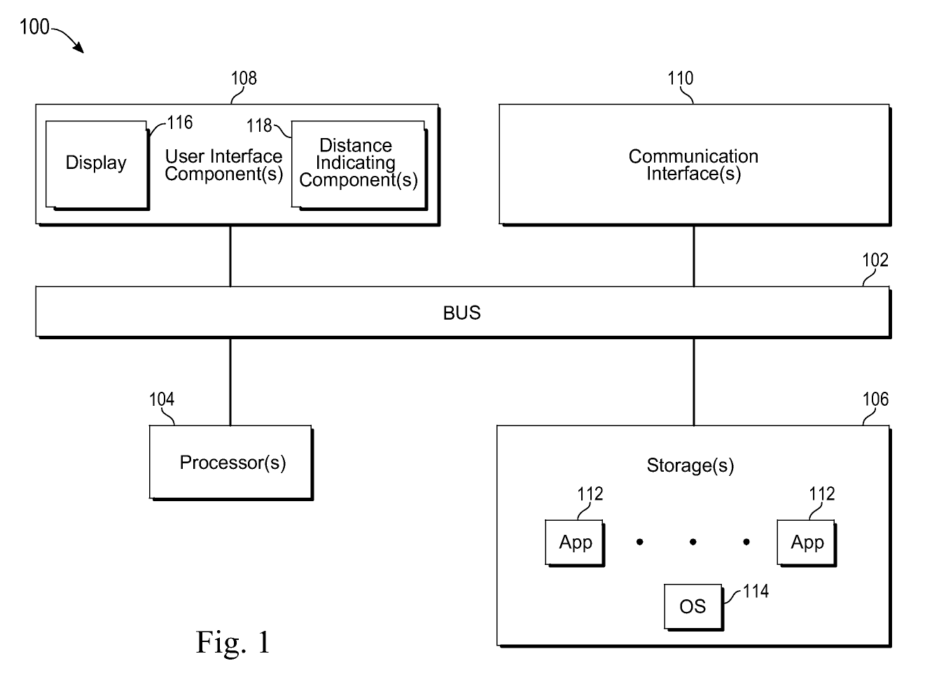

With reference to FIG. 1, there is shown a block diagram of a sample computing device 100 in which one embodiment of the present invention may be implemented. As shown, device 100 includes a bus 102 for facilitating information exchange, and one or more processors 104 coupled to bus 102 for executing instructions and processing information. Device 100 also includes one or more storages 106 (also referred to herein as computer readable storage media) coupled to the bus 102. Storage(s) 106 may be used to store executable programs, permanent data, temporary data that is generated during program execution, and any other information needed to carry out computer processing.

Storage(s) 106 may include any and all types of storages that may be used to carry out computer processing. For example, storage(s) 106 may include main memory (e.g. random access memory (RAM) or other dynamic storage device), cache memory, read only memory (ROM), permanent storage (e.g. one or more magnetic disks or optical disks, flash storage, etc.), as well as other types of storage. The various storages 106 may be volatile or non-volatile. Common forms of computer readable storage media include, for example, a floppy disk, a flexible disk, hard disk, magnetic tape, or any other magnetic medium, a CD-ROM, DVD, or any other optical storage medium, punchcards, papertape, or any other physical medium with patterns of holes, a RAM, a PROM, an EPROM, a FLASH-EPROM or any other type of flash memory, any memory chip or cartridge, and any other storage medium from which a computer can read.

As shown in FIG. 1, storage(s) 106 store at least several sets of executable instructions, including an operating system 114 and one or more applications 112. The processor(s) 102 execute the operating system 114 to provide a platform on which other sets of software may operate, and execute one or more of the applications 112 to provide additional, specific functionality. For purposes of the present invention, the applications 112 may be any type of application that generates visual content that can be scaled to different sizes. In one embodiment, the automatic scaling functionality described herein is provided by the operating system 114 as a service to the applications 112. Thus, when an application 112 has a set of visual content that it wants to render to a user, it calls to the operating system 114 and asks for a scaling factor. It then uses the scaling factor to scale the visual content. As an alternative, the application 112 may provide the visual content to the operating system 114, and ask the operating system 114 to scale the visual content according to a scaling factor determined by the operating system 114. As an alternative to having the operating system 114 provide the automatic scaling functionality, the automatic scaling functionality may instead be provided by the applications 112 themselves. As a further alternative, the automatic scaling functionality may be provided by a combination of or cooperation between the operating system 114 and one or more of the applications 112. All such possible divisions of functionality are within the scope of the present invention.

The device 100 further comprises one or more user interface components 108 coupled to the bus 102. These components 108 enable the device 100 to receive input from and provide output to a user. On the input side, the user interface components 108 may include, for example, a keyboard/keypad having alphanumeric keys, a cursor control device (e.g. mouse, trackball, touchpad, etc.), a touch sensitive screen, a microphone for receiving audio input, etc. On the output side, the components 108 may include a graphical interface (e.g. a graphics card) and an audio interface (e.g. sound card) for providing visual and audio content. The user interface components 108 may further include a display 116, a set of speakers, etc., for presenting the audio and visual content to a user. In one embodiment, the operating system 114 and the one or more applications 112 executed by the processor(s) 104 may provide a software user interface that takes advantage of and interacts with the user interface components 108 to receive input from and provide output to a user. This software user interface may, for example, provide a menu that the user can navigate using one of the user input devices mentioned above.

The user interface components 108 further include one or more distance indicating components 118. These components 118, which in one embodiment are situated on or near the display 116, provide information indicating how far a user's face is from the display 116. Examples of distance indicating components 118 include but are not limited to: an infrared (IR) sensor (which includes an IR emitter and an IR receiver that detects the IR signal reflected from a surface); a laser sensor (which includes a laser emitter and a laser sensor that detects the laser signal reflected from a surface); a SONAR sensor (which includes an audio emitter and an audio sensor that detects the audio signal reflected from a surface); and a user-facing camera. With an IR sensor, the distance between the IR sensor and a surface (e.g. a user's face) may be calculated based upon the intensity of the IR signal that is reflected back from the surface and detected by the IR sensor. With a laser sensor and a SONAR sensor, the distance between the sensor and a surface may be calculated based upon how long it takes for a signal to bounce back from the surface. With a user-facing camera, distance may be determined based upon the dimensions of a certain feature of a user's face (e.g. the distance between the user's eyes). Specifically, the closer a user is to the camera, the larger the dimensions of the feature would be. In one embodiment, the one or more distance indicating components 118 provide the sensor information needed to determine how close a user's face is to the display 116.

In addition to the components set forth above, the device 100 further comprises one or more communication interfaces 110 coupled to the bus 102. These interfaces 110 enable the device 100 to communicate with other components. The communication interfaces 110 may include, for example, a network interface (wired or wireless) for enabling the device 100 to send messages to and receive messages from a network. The communications interfaces 110 may further include a wireless interface (e.g. Bluetooth) for communicating wirelessly with nearby devices, and a wired interface for direct coupling with a compatible local device. Furthermore, the communications interfaces 110 may include a 3G interface for enabling the device to access the Internet without using a local network. These and other interfaces may be included in the device 100.

### Sample Operation

With the above description in mind, and with reference to FIGS. 1-5, the operation of device 100 in accordance with several embodiments of the present invention will now be described. In the following description, it will be assumed for the sake of illustration that the automatic scaling functionality is provided by the operating system 114. However, as noted above, this is just one possible implementation. Other implementations where the automatic scaling functionality is provided by the applications 112 themselves or by a combination of or cooperation between the operating system 114 and one or more of the applications 112 are also possible. All such implementations are within the scope of the present invention.

As mentioned above, the device 100 includes one or more distance indicating components 118. In one embodiment, a distance indicating component 118 may be one of two types of components: (1) a distance determining component such as an IR sensor, a laser sensor, a SONAR sensor, etc.; or (2) a user-facing camera. Because automatic scaling is carried out slightly differently depending upon whether component 118 is a distance determining component or a user-facing camera, the automatic scaling functionality will be described separately for each type of component. For the sake of simplicity, the following description will assume that there is only one distance indicating component 118 in the device 100. However, it should be noted that more distance indicating components 118 may be included and used if so desired.

### Operation Using a Distance Determining Component

### Calibration

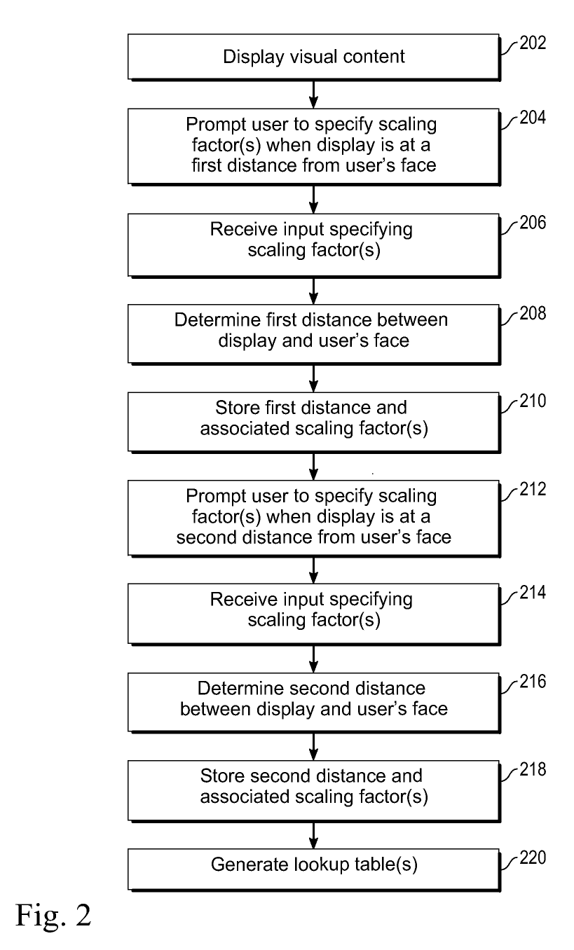

In one embodiment, before automatic scaling is carried out using a distance determining component, a calibration procedure is performed. This calibration procedure allows the operating system 114 to tailor the automatic scaling to a user's particular preference. A flow diagram showing the calibration procedure in accordance with one embodiment of the present invention is provided in FIG. 2.

In performing the calibration procedure, the operating system 114 initially displays (block 202) a set of visual content (which in one embodiment includes both text and a graphics image) on the display 116 of device 100. The operating system 114 then prompts (block 204) the user to hold the display 116 at a first distance from the user's face and to adjust the visual content to a size that is comfortable for the user at that distance. In one embodiment, the first distance may be the closest distance that the user would expect to have his/her face to the display 116. In response to this prompt, the user uses the user interface components 108 of device 100 to scale the visual content to a size that is comfortable for him/her at the first distance. The user may do this, for example, using keys on a keyboard, a mouse, a touch sensitive screen (e.g. by pinching or spreading two fingers), or some other input mechanism. By doing so, the user is in effect providing input indicating the scaling factor(s) that the user would like the operating system 114 to use to scale visual content at this first distance. In one embodiment, the scaling factor(s) may include a preferred font size for the text and a preferred magnification factor for the graphics image.

The operating system 114 receives (block 206) this user input. In addition, the operating system 114 receives some sensor information from the distance determining component (e.g. the IR sensor, the laser sensor, the SONAR sensor, etc.), and uses this information to determine (block 208) the current distance between the user's face and the display 116. In the case of an IR sensor, the operating system 114 receives an intensity value (indicating the intensity of the IR signal sensed by the IR sensor). Based upon this value and perhaps a table of intensity-to-distance values (not shown), the operating system 114 determines a current distance between the user's face and the display 116. In the case of a laser or SONAR sensor, the operating system 114 receives a time value (indicating how long it took for the laser or SONAR signal to bounce back from the user's face). Based upon this value and perhaps a table of timing-to-distance values (not shown), the operating system 114 determines a current distance between the user's face and the display 116. After the current distance is determined, it is stored (block 210) along with the scaling factors; thus, at this point, the operating system 114 knows the first distance and the scaling factor(s) that should be applied at that distance.

To continue the calibration procedure, the operating system 114 prompts (block 212) the user to hold the display 116 at a second distance from the user's face and to adjust the visual content to a size that is comfortable for the user at that distance. In one embodiment, the second distance may be the farthest distance that the user would expect to have his/her face from the display 116. In response to this prompt, the user uses the user interface components 108 to scale the visual content on the display to a size that is comfortable for him/her at the second distance. The user may do this in a manner similar to that described above. By doing so, the user is in effect providing input indicating the scaling factor(s) that the user would like the operating system 114 to use to scale visual content at the second distance. Again, the scaling factor(s) may include a preferred font size for the text and a preferred magnification factor for the graphics image.

The operating system 114 receives (block 214) this user input. In addition, the operating system 114 receives some sensor information from the distance determining component, and uses this information to determine (block 216) the current distance between the user's face and the display 116. This distance determination may be performed in the manner described above. After the current distance is determined, it is stored (stored 218) along with the scaling factor(s); thus, at this point, in addition to knowing the first distance and its associated scaling factor(s), the operating system 114 also knows the second distance and its associated scaling factor(s). With these two sets of data, the operating system 114 can use interpolation to determine the scaling factor(s) that should be applied for any distance between the first and second distances.

The above calibration procedure may be used to perform calibration for both the comfort mode and the zoom mode. The difference will mainly be that the scaling factor(s) specified by the user will be different for the two modes. That is, for comfort mode, the user will specify a smaller scaling factor(s) at the first (shorter) distance than at the second (longer) distance, but for zoom mode, the user will specify a larger scaling factor(s) at the first distance than at the second distance. Other than that, the overall procedure is generally similar. In one embodiment, the calibration procedure is performed twice: once for comfort mode and once for zoom mode.

After calibration is performed, the operating system 114, in one embodiment, generates (block 220) one or more lookup tables for subsequent use. Such a lookup table may contain multiple entries, and each entry may include a distance value and an associated set of scaling factor value(s). One entry may contain the first distance and the set of scaling factor value(s) specified by the user for the first distance. Another entry may contain the second distance and the set of scaling factor value(s) specified by the user for the second distance. The lookup table may further include other entries that have distances and scaling factor value(s) that are generated based upon these two entries. For example, using linear interpolation, the operating system 114 can generate multiple entries with distance and scaling factor value(s) that are between the distances and scaling factor value(s) of the first and second distances. For example, if the first distance is A and the second distance is B, and if a first scaling factor associated with distance A is X and a second scaling factor associated with distance B is Y, then for a distance C that is between A and B, the scaling factor can be computed using linear interpolation as follows:

Z=X+(Y−X)*(C−A)/(B−A)

where Z is the scaling factor associated with distance C.

Using this methodology, the operating system 114 can populate the lookup table with many entries, with each entry containing a distance and an associated set of scaling factor value(s). Such a lookup table may thereafter be used during regular operation to determine a scaling factor(s) for any given distance. In one embodiment, the operating system 114 generates two lookup tables: one for comfort mode and another for zoom mode. Once generated, the lookup tables are ready to be used during regular operation.

In the above example, the lookup tables are generated using linear interpolation. It should be noted that this is not required. If so desired, other types of interpolation (e.g. non-linear, exponential, geometric, etc.) may be used instead. Also, the operating system 114 may choose not to generate any lookup tables at all. Instead, the operating system 114 may calculate scaling factors on the fly. These and other alternative implementations are within the scope of the present invention.

### Regular Operation

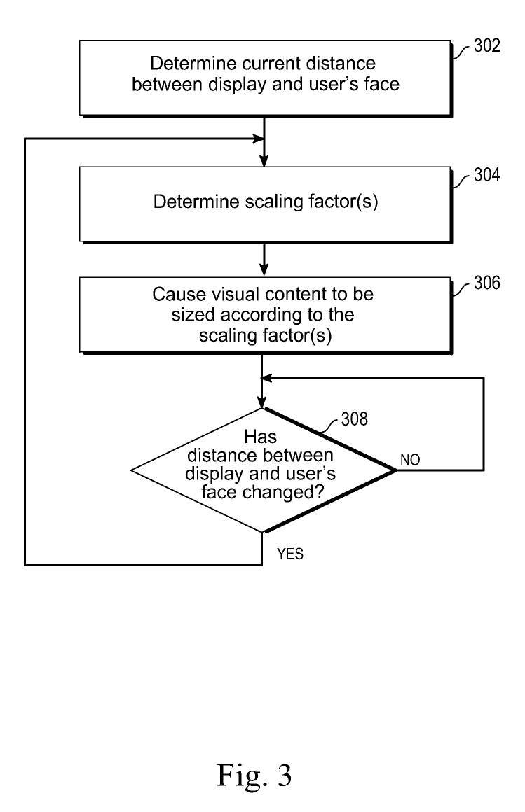

After the calibration procedure is performed, the operating system 114 is ready to implement automatic scaling during regular operation. A flow diagram illustrating regular operation in accordance with one embodiment of the present invention is shown in FIG. 3.

Initially, the operating system 114 receives a request from one of the applications 112 to provide the automatic scaling service. In one embodiment, the request specifies whether comfort mode or zoom mode is desired. In response to the request, the operating system 114 determines (block 302) a current distance between the user's face and the display 116. This may be done by receiving sensor information from the distance determining component (e.g. the IR sensor, laser sensor, SONAR sensor, etc.) and using the sensor information to determine (in the manner described previously) how far the user's face currently is from the display 116.

Based at least in part upon this current distance, the operating system 114 determines (block 304) a set of scaling factor(s). In one embodiment, the set of scaling factor(s) is determined by accessing an appropriate lookup table (e.g. the comfort mode table or the zoom mode table) generated during the calibration process, and accessing the appropriate entry in the lookup table using the current distance as a key. In many instances, there may not be an exact match between the current distance and a distance in the table. In such a case, the operating system 114 may select the entry with the closest distance value. From that entry, the operating system 114 obtains a set of scaling factor(s). As an alternative to accessing a lookup table, the operating system 114 may calculate the set of scaling factor(s) on the fly. In one embodiment, if the current distance is shorter than the first (closest) distance determined during calibration, the operating system 114 will use the scaling factor(s) provided by the user in association with the first distance. If the current distance is longer than the second (farthest) distance determined during calibration, the operating system 114 will use the scaling factor(s) provided by the user in association with the second distance.

After the set of scaling factor(s) is determined, the operating system 114 causes (block 306) a set of visual content to be sized in accordance with the set of scaling factor(s). In one embodiment, the operating system 114 may do this by: (1) providing the set of scaling factor(s) to the calling application and having the calling application scale the visual content in accordance with the set of scaling factor(s); or (2) receiving the visual content from the calling application, and scaling the visual content for the calling application in accordance with the set of scaling factor(s). Either way, when the visual content is rendered on the display 116, it will have a scale appropriate for the current distance between the user's face and the display 116.

Thereafter, the operating system 114 periodically checks (block 308) to determine whether the distance between the user's face and the display 116 has changed. The operating system 114 may do this by periodically receiving sensor information from the distance determining component and using that information to determine a current distance between the user's face and the display 116. This current distance is compared against the distance that was used to determine the set of scaling factor(s). If the distances are different, then the operating system 114 may proceed to rescale the visual content. In one embodiment, the operating system 114 will initiate a rescaling of the visual content only if the difference in distances is greater than a certain threshold. If the difference is below the threshold, the operating system 114 will leave the scaling factor(s) the same. Implementing this threshold prevents the scaling factor(s), and hence the size of the visual content, from constantly changing in response to small changes in distance, which may be distracting and uncomfortable for the user.

In block 308, if the operating system 114 determines that the difference between the current distance and the distance that was used to determine the set of scaling factor(s) is less than the threshold, then the operating system 114 loops back and continues to check (block 308) to see if the distance between the user's face and the display 116 has changed. On the other hand, if the operating system 114 determines that the difference between the current distance and the distance that was used to determine the set of scaling factor(s) is greater than the threshold, then the operating system 114 proceeds to rescale the visual content.

In one embodiment, the operating system 114 rescales the visual content by looping back to block 304 and determining a new set of scaling factor(s) based at least in part upon the new current distance. In one embodiment, the new set of scaling factor(s) is determined by accessing the appropriate lookup table (e.g. the comfort mode table or the zoom mode table), and accessing the appropriate entry in that lookup table using the new current distance as a key. As an alternative, the operating system 114 may calculate the new set of scaling factor(s) on the fly.

After the new set of scaling factor(s) is determined, the operating system 114 causes (block 306) the visual content to be resized in accordance with the new set of scaling factor(s). In one embodiment, the operating system 114 may do this by providing the new set of scaling factor(s) to the calling application and having the calling application rescale the visual content in accordance with the new set of scaling factor(s), or by receiving the visual content from the calling application and rescaling the visual content for the calling application in accordance with the new set of scaling factor(s). Either way, when the visual content is rendered on the display 116, it will have a new scale appropriate for the new current distance between the user's face and the display 116.

After the visual content is rescaled, the operating system 114 proceeds to block 308 to once again determine whether the distance between the user's face and the display 116 has changed. If so, the operating system 114 may rescale the visual content again. In the manner described, the device 100 automatically scales the size of a set of visual content in response to the distance between a user's face and the display 116.

### Operation Using a User-Facing Camera

### Calibration

The above discussion describes how automatic scaling may be carried out using a distance determining component. In one embodiment, automatic scaling may also be performed using a user-facing camera. The following discussion describes how this may be done, in accordance with one embodiment of the present invention.

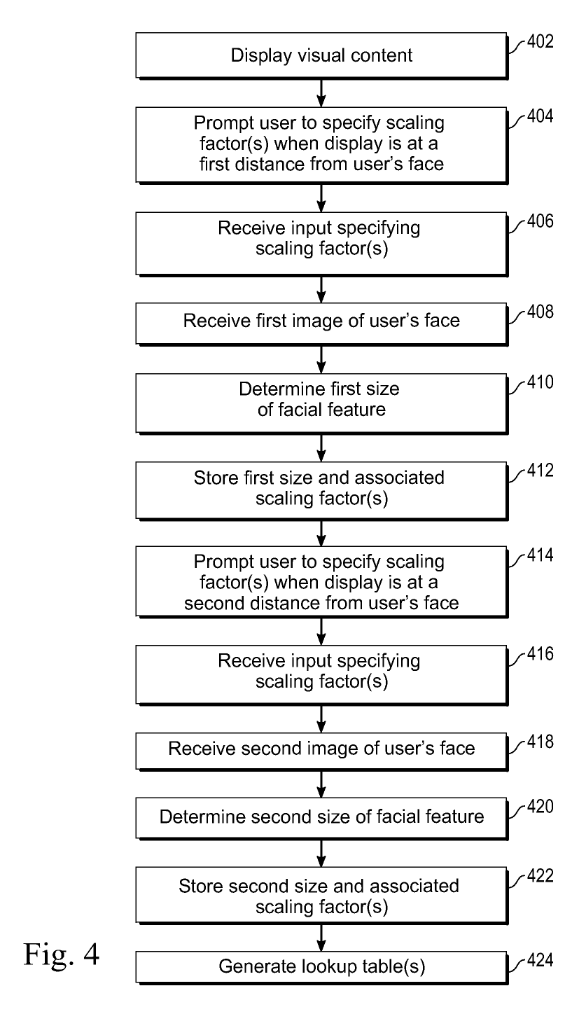

In one embodiment, before automatic scaling is carried out using a user-facing camera, a calibration procedure is performed. This calibration procedure allows the operating system 114 to tailor the automatic scaling to a user's particular preference. A flow diagram showing the calibration procedure in accordance with one embodiment of the present invention is provided in FIG. 4.

In performing the calibration procedure, the operating system 114 initially displays (block 402) a set of visual content (which in one embodiment includes both text and a graphics image) on the display 116 of device 100. The operating system 114 then prompts (block 404) the user to hold the display 116 at a first distance from the user's face and to adjust the visual content to a size that is comfortable for the user at that distance. In one embodiment, the first distance may be the closest distance that the user would expect to have his/her face to the display 116. In response to this prompt, the user uses the user interface components 108 of device 100 to scale the visual content to a size that is comfortable for him/her at the first distance. The user may do this, for example, using keys on a keyboard, a mouse, a touch sensitive screen (e.g. by pinching or spreading two fingers), or some other input mechanism. By doing so, the user is in effect providing input indicating the scaling factor(s) that the user would like the operating system 114 to use to scale visual content at this first distance. In one embodiment, the scaling factor(s) may include a preferred font size for the text and a preferred magnification factor for the graphics image.

The operating system 114 receives (block 406) this user input. In addition, the operating system 114 causes the user-facing camera to capture a current image of the user's face, and receives (block 408) this captured image from the camera. Using the captured image, the operating system 114 determines (block 410) the current size or dimensions of a certain feature of the user's face. For purposes of the present invention, any feature of the user's face may be used for this purpose, including but not limited to the distance between the user's eyes, the distance from one side of the user's head to the other, etc. In the following example, it will be assumed that the distance between the user's eyes is the feature that is measured.

In one embodiment, this distance may be measured using facial recognition techniques. More specifically, the operating system 114 implements, or invokes a routine (not shown) that implements, a facial recognition technique to analyze the captured image to locate the user's eyes. The user's eyes may be found, for example, by looking for two relatively round dark areas (the pupils) surrounded by white areas (the whites of the eyes). Facial recognition techniques capable of performing this type of operation is relatively well known (see, for example, W. Zhao, R. Chellappa, A. Rosenfeld, P. J. Phillips, Face Recognition: A Literature Survey, ACM Computing Surveys, 2003, pp. 399-458, a portion of which is included as an appendix). Once the eyes are found, the distance between the eyes (which in one embodiment is measured from the center of one pupil to the center of the other pupil) is measured. In one embodiment, this measurement may be expressed in terms of the number of pixels between the centers of the pupils. This measurement provides an indication of how far the user's face is from the display 116. That is, when the number of pixels between the user's eyes is this value, the user's face is at the first distance from the display 116.

After the number of pixels between the user's eyes is measured, it is stored (block 412) along with the scaling factors; thus, at this point, the operating system 114 knows the number of pixels between the user's eyes when the user's face is at the first distance, and it knows the scaling factor(s) that should be applied when the number of pixels between the user's eyes is at this value.

To continue the calibration procedure, the operating system 114 prompts (block 414) the user to hold the display 116 at a second distance from the user's face and to adjust the visual content to a size that is comfortable for the user at that distance. In one embodiment, the second distance may be the farthest distance that the user would expect to have his/her face from the display 116. In response to this prompt, the user uses the user interface components 108 to scale the visual content on the display to a size that is comfortable for him/her at the second distance. The user may do this in a manner similar to that described above. By doing so, the user is in effect providing input indicating the scaling factor(s) that the user would like the operating system 114 to use to scale visual content at the second distance. Again, the scaling factor(s) may include a preferred font size for the text and a preferred magnification factor for the graphics image.

The operating system 114 receives (block 416) this user input. In addition, the operating system 114 causes the user-facing camera to capture a second image of the user's face, and receives (block 418) this captured image from the camera. Using the second captured image, the operating system 114 determines (block 420) the number of pixels between the user's eyes when the user's face is at the second distance from the display 116. This may be done in the manner described above. Since, in the second image, the user's face is farther from the display 116, the number of pixels between the user's eyes in the second image should be fewer than in the first image. After the number of pixels between the user's eyes is determined, it is stored (stored 422) along with the scaling factor(s). Thus, at this point, the operating system 114 has two sets of data: (1) a first set that includes the number of pixels between the user's eyes at the first distance and the scaling factor(s) to be applied at the first distance; and (2) a second set that includes the number of pixels between the user's eyes at the second distance and the scaling factor(s) to be applied at the second distance. With these two sets of data, the operating system 114 can use interpolation to determine the scaling factor(s) that should be applied for any distance between the first and second distances. For the sake of convenience, the number of pixels between the user's eyes at the first distance will be referred to below as the “first number of pixels”, and the number of pixels between the user's eyes at the second distance will be referred to below as the “second number of pixels”.

The above calibration procedure may be used to perform calibration for both the comfort mode and the zoom mode. The difference will mainly be that the scaling factor(s) specified by the user will be different for the two modes. That is, for comfort mode, the user will specify a smaller scaling factor(s) at the first (shorter) distance than at the second (longer) distance, but for zoom mode, the user will specify a larger scaling factor(s) at the first distance than at the second distance. Other than that, the overall procedure is generally similar. In one embodiment, the calibration procedure is performed twice: once for comfort mode and once for zoom mode.

After calibration is performed, the operating system 114, in one embodiment, generates (block 424) one or more lookup tables for subsequent use. Such a lookup table may contain multiple entries, and each entry may include a “number of pixels” value and an associated set of scaling factor(s) value(s). One entry may contain the “first number of pixels” and the set of scaling factor value(s) specified by the user for the first distance. Another entry may contain the “second number of pixels” and the set of scaling factor value(s) specified by the user for the second distance. The lookup table may further include other entries that have “number of pixels” values and scaling factor value(s) that are generated based upon these two entries. For example, using linear interpolation, the operating system 114 can generate multiple entries with “number of pixels” values that are between the “first number of pixels” and the “second number of pixels” and scaling factor value(s) that are between the first and second sets of associated scaling factor values(s). For example, if the “first number of pixels” is A and the “second number of pixels” is B, and if a first scaling factor associated with the first distance is X and a second scaling factor associated with the second distance is Y, then for a “number of pixels” C that is between A and B, the scaling factor can be computed using linear interpolation as follows:

Z=X+(Y−X)*(C−A)/(B−A)

where Z is the scaling factor associated with the “number of pixels” C.

Using this methodology, the operating system 114 can populate the lookup table with many entries, with each entry containing a “number of pixels” value (which provides an indication of how far the user's face is from the display 116) and an associated set of scaling factor value(s). Such a lookup table may thereafter be used during regular operation to determine a scaling factor(s) for any given “number of pixels” value. In one embodiment, the operating system 114 generates two lookup tables: one for comfort mode and another for zoom mode. Once generated, the lookup tables are ready to be used during regular operation.

In the above example, the lookup tables are generated using linear interpolation. It should be noted that this is not required. If so desired, other types of interpolation (e.g. non-linear, exponential, geometric, etc.) may be used instead. Also, the operating system 114 may choose not to generate any lookup tables at all. Instead, the operating system 114 may calculate scaling factors on the fly. These and other alternative implementations are within the scope of the present invention.

### Regular Operation

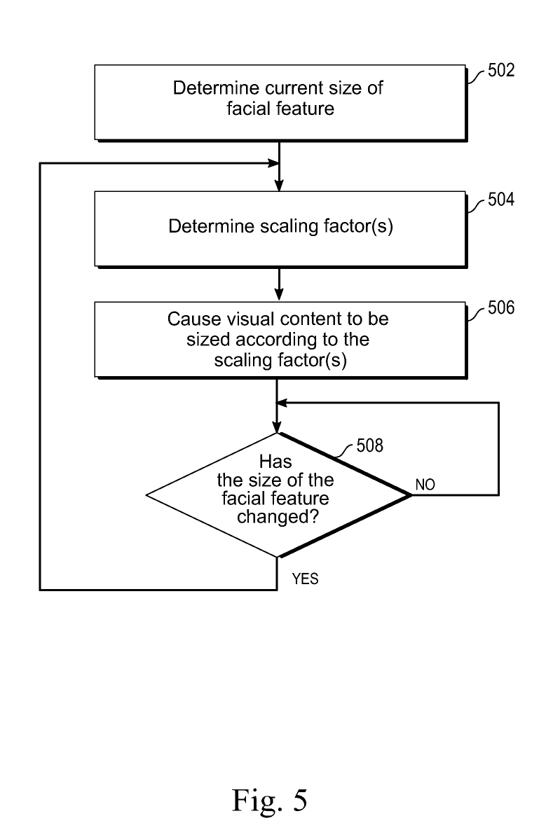

After the calibration procedure is performed, the operating system 114 is ready to implement automatic scaling during regular operation. A flow diagram illustrating regular operation in accordance with one embodiment of the present invention is shown in FIG. 5.

Initially, the operating system 114 receives a request from one of the applications 112 to provide the automatic scaling service. In one embodiment, the request specifies whether comfort mode or zoom mode is desired. In response to the request, the operating system 114 determines (block 502) a current size of a facial feature of the user. In one embodiment, this entails measuring the number of pixels between the eyes of the user. This may be done by causing the user-facing camera to capture a current image of the user, and receiving this captured image from the camera. Using the captured image, the operating system 114 measures (in the manner described above) how many pixels are between the pupils of the user's eyes. This current “number of pixels” value provides an indication of how far the user's face currently is from the display 116.

Based at least in part upon this current “number of pixels” value, the operating system 114 determines (block 504) a set of scaling factor(s). In one embodiment, the set of scaling factor(s) is determined by accessing an appropriate lookup table (e.g. the comfort mode table or the zoom mode table) generated during the calibration process, and accessing the appropriate entry in the lookup table using the current “number of pixels” value as a key. In many instances, there may not be an exact match between the current “number of pixels” value and a “number of pixels” value in the table. In such a case, the operating system 114 may select the entry with the closest “number of pixels” value. From that entry, the operating system 114 obtains a set of scaling factor(s). As an alternative to accessing a lookup table, the operating system 114 may calculate the set of scaling factor(s) on the fly. In one embodiment, if the current “number of pixels” value is smaller than the “first number of pixels” determined during calibration, the operating system 114 will use the scaling factor(s) associated with the “first number of pixels”. If the current “number of pixels” value is larger than the “second number of pixels” determined during calibration, the operating system 114 will use the scaling factor(s) associated with the “second number of pixels”.

After the set of scaling factor(s) is determined, the operating system 114 causes (block 506) a set of visual content to be sized in accordance with the set of scaling factor(s). In one embodiment, the operating system 114 may do this by: (1) providing the set of scaling factor(s) to the calling application and having the calling application scale the visual content in accordance with the set of scaling factor(s); or (2) receiving the visual content from the calling application, and scaling the visual content for the calling application in accordance with the set of scaling factor(s). Either way, when the visual content is rendered on the display 116, it will have a scale appropriate for the current number of pixels between the user's eyes (and hence, for the current distance between the user's face and the display 116).

Thereafter, the operating system 114 periodically checks (block 508) to determine whether the number of pixels between the user's eyes has changed. The operating system 114 may do this by periodically receiving captured images of the user's face from the user-facing camera, and measuring the current number of pixels between the user's eyes. This current number of pixels is compared against the number of pixels that was used to determine the set of scaling factor(s). If the numbers of pixels are different, then the operating system 114 may proceed to rescale the visual content. In one embodiment, the operating system 114 will initiate a rescaling of the visual content only if the difference in numbers of pixels is greater than a certain threshold. If the difference is below the threshold, the operating system 114 will leave the scaling factor(s) the same. Implementing this threshold prevents the scaling factor(s), and hence the size of the visual content, from constantly changing in response to small changes in the numbers of pixels, which may be distracting and uncomfortable for the user.

In block 508, if the operating system 114 determines that the difference between the current number of pixels and the number of pixels that was used to determine the set of scaling factor(s) is less than the threshold, the operating system 114 loops back and continues to check (block 508) to see if the number of pixels between the user's eyes has changed. On the other hand, if the operating system 114 determines that the difference between the current number of pixels and the number of pixels that was used to determine the set of scaling factor(s) is greater than the threshold, then the operating system 114 proceeds to rescale the visual content.

In one embodiment, the operating system 114 rescales the visual content by looping back to block 504 and determining a new set of scaling factor(s) based at least in part upon the new current number of pixels. In one embodiment, the new set of scaling factor(s) is determined by accessing the appropriate lookup table (e.g. the comfort mode table or the zoom mode table), and accessing the appropriate entry in that lookup table using the new current number of pixels as a key. As an alternative, the operating system 114 may calculate the new set of scaling factor(s) on the fly.

After the new set of scaling factor(s) is determined, the operating system 114 causes (block 506) the visual content to be resized in accordance with the new set of scaling factor(s). In one embodiment, the operating system 114 may do this by providing the new set of scaling factor(s) to the calling application and having the calling application rescale the visual content in accordance with the new set of scaling factor(s), or by receiving the visual content from the calling application and rescaling the visual content for the calling application in accordance with the new set of scaling factor(s). Either way, when the visual content is rendered on the display 116, it will have a new scale appropriate for the new current number of pixels between the user's eyes (and hence, appropriate for the current distance between the user's face and the display 116.

After the visual content is rescaled, the operating system 114 proceeds to block 508 to once again determine whether the distance between the user's eyes has changed. If so, the operating system 114 may rescale the visual content again. In the manner described, the device 100 automatically scales the size of a set of visual content in response to how close a user's face is to a display.

In the foregoing specification, embodiments of the present invention have been described with reference to numerous specific details that may vary from implementation to implementation. Thus, the sole and exclusive indicator of what is the invention, and is intended by the Applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
causing a set of visual content on a display to be sized according to a first scaling factor, wherein a user's face is currently at a first distance from the display;
determining that the user's face has moved relative to the display such that the user's face is no longer at the first distance from the display; and
in response to determining that the user's face has moved relative to the display, causing the set of visual content on the display to be sized according to a second and different scaling factor to cause a display size of the set of visual content to change.

2. The method of claim 1, wherein determining that the user's face has moved relative to the display comprises:
determining whether the user's face has moved closer to or farther from the display.

3. The method of claim 2, wherein causing the set of visual content to be sized according to a second scaling factor comprises:
in response to determining that the user's face has moved closer to the display, causing the set of visual content to be scaled to a second scaling factor that causes the display size of the set of visual content to be reduced; and
in response to determining that the user's face has moved farther from the display, causing the set of visual content to be scaled to a second scaling factor that causes the display size of the set of visual content to be enlarged.

4. The method of claim 2, wherein causing the set of visual content to be sized according to a second scaling factor comprises:
in response to determining that the user's face has moved closer to the display, causing the set of visual content to be scaled to a second scaling factor that causes the display size of the set of visual content to be enlarged; and
in response to determining that the user's face has moved farther from the display, causing the set of visual content to be scaled to a second scaling factor that causes the display size of the set of visual content to be reduced.

5. The method of claim 1, wherein the visual content includes text, and wherein the first and second scaling factors represent different font sizes.

6. The method of claim 1, wherein the visual content includes a graphic, and wherein the first and second scaling factors represent different magnification factors.

7. A computer readable storage medium having instructions stored thereon which, when executed by one or more processors, cause the one or more processors to perform the method of claim 1.

8. A computer readable storage medium having instructions stored thereon which, when executed by one or more processors, cause the one or more processors to perform the method of claim 2.

9. A computer readable storage medium having instructions stored thereon which, when executed by one or more processors, cause the one or more processors to perform the method of claim 3.

10. A computer readable storage medium having instructions stored thereon which, when executed by one or more processors, cause the one or more processors to perform the method of claim 4.

11. An apparatus, comprising:
one or more processors; and
one or more storages having instructions stored thereon which, when executed by the one or more processors, cause the one or more processors to perform the operations of:
causing a set of visual content on a display to be sized according to a first scaling factor,
wherein a user's face is currently at a first distance from the display;
determining that the user's face has moved relative to the display such that the user's face is no longer at the first distance from the display; and
in response to determining that the user's face has moved relative to the display, causing the set of visual content on the display to be sized according to a second and different scaling factor to cause a display size of the set of visual content to change.

12. A method, comprising:
determining that a user's face is at a first distance from a display;
determining, based at least in part upon the first distance, a first scaling factor;
causing a set of visual content on the display to be sized according to the first scaling factor;
determining that the user's face has moved to a second distance from the display, wherein the second distance is different from the first distance;
determining, based at least in part upon the second distance, a second scaling factor, wherein the second scaling factor is different from the first scaling factor; and
causing the set of visual content to be sized according to the second scaling factor to cause a display size of the set of visual content to change.

13. The method of claim 12, further comprising:
performing a calibration procedure, wherein the calibration procedure comprises:
receiving input from the user indicating a first desired scaling factor when the user's face is at a first calibration distance from the display; and
receiving input from the user indicating a second desired scaling factor when the user's face is at a second and different calibration distance from the display.

14. The method of claim 12, wherein:
determining that a user's face is at a first distance from a display comprises:
receiving information from a distance indicating component indicating that the user's face is at the first distance from the display; and
determining that the user's face has moved to a second distance from the display comprises:
receiving information from the distance indicating component indicating that the user's face is at the second distance from the display.

15. The method of claim 12, wherein:
determining that a user's face is at a first distance from a display comprises:
receiving a first set of sensor information from a sensing device; and
using the first set of sensor information to determine that the user's face is at the first distance from the display; and
determining that the user's face has moved to a second distance from the display comprises:
receiving a second set of sensor information from the sensing device; and
using the second set of sensor information to determine that the user's face is at the second distance from the display.

16. The method of claim 15, wherein the sensing device is one of: an infrared distance sensing device; a laser distance sensing device; a SONAR distance sensing device; and an image capture device for capturing an image of the user's face.

17. A computer readable storage medium having instructions stored thereon which, when executed by one or more processors, cause the one or more processors to perform the method of claim 12.

18. A computer readable storage medium having instructions stored thereon which, when executed by one or more processors, cause the one or more processors to perform the method of claim 13.

19. An apparatus, comprising:
one or more processors; and
one or more storages having instructions stored thereon which, when executed by the one or more processors, cause the one or more processors to perform the operations of:
determining that a user's face is at a first distance from a display;
determining, based at least in part upon the first distance, a first scaling factor;
causing a set of visual content on the display to be sized according to the first scaling factor;
determining that the user's face has moved to a second distance from the display, wherein the second distance is different from the first distance;
determining, based at least in part upon the second distance, a second scaling factor, wherein the second scaling factor is different from the first scaling factor; and
causing the set of visual content to be sized according to the second scaling factor to cause a display size of the set of visual content to change.

20. The apparatus of claim 19, further comprising:
a sensing device, which is one of: an infrared distance sensing device; a laser distance sensing device; a SONAR distance sensing device; and an image capture device for capturing an image of the user's face.

21. A method, comprising:
from a first captured image of a user's face, determining that a particular facial feature has a first size;
determining, based at least in part upon the first size, a first scaling factor;
causing a set of visual content on a display to be sized according to the first scaling factor;
from a second captured image of the user's face, determining that the same particular facial feature is of a second size, wherein the second size is different from the first size;
determining, based at least in part upon the second size, a second scaling factor, wherein the second scaling factor is different from the first scaling factor; and
causing the set of visual content to be sized according to the second scaling factor to cause a display size of the set of visual content to change.

22. The method of claim 21, wherein the particular facial feature is a separation between two distinct portions of the user's face.

23. The method of claim 22, wherein the first and second captured images of the user's face comprise a plurality of pixels, wherein the first size indicates a first number of pixels spanned by the separation between the two distinct portions of the user's face in the first captured image, and wherein the second size indicates a second number of pixels spanned by the separation between the two distinct portions of the user's face in the second captured image.

24. The method of claim 21, further comprising:
performing a calibration procedure, wherein the calibration procedure comprises:
from a first calibration image of the user's face captured while the user's face is at a first distance from the display, determining that the particular facial feature has a first calibration size;
while the user's face is at the first distance from the display, receiving input from the user indicating a first desired scaling factor;
from a second calibration image of the user's face captured while the user's face is at a second distance from the display, determining that the particular facial feature has a second calibration size, wherein the second distance is different from the first distance and the second calibration size is different from the first calibration size; and
while the user's face is at the second distance from the display, receiving input from the user indicating a second desired scaling factor, wherein the second desired scaling factor is different from the first scaling factor.

25. A computer readable storage medium having instructions stored thereon which, when executed by one or more processors, cause the one or more processors to perform the method of claim 21.

26. A computer readable storage medium having instructions stored thereon which, when executed by one or more processors, cause the one or more processors to perform the method of claim 23.

27. A computer readable storage medium having instructions stored thereon which, when executed by one or more processors, cause the one or more processors to perform the method of claim 24.

28. An apparatus, comprising:
one or more processors; and
one or more storages having instructions stored thereon which, when executed by the one or more processors, cause the one or more processors to perform the operations of:
from a first captured image of a user's face, determining that a particular facial feature has a first size;
determining, based at least in part upon the first size, a first scaling factor;
causing a set of visual content on a display to be sized according to the first scaling factor;
from a second captured image of the user's face, determining that the same particular facial feature is of a second size, wherein the second size is different from the first size;
determining, based at least in part upon the second size, a second scaling factor, wherein the second scaling factor is different from the first scaling factor; and
causing the set of visual content to be sized according to the second scaling factor to cause a display size of the set of visual content to change.

29. The apparatus of claim 28, further comprising:
an image capturing device for capturing the first and second captured images of the user's face.
